(19) United States
(12) Patent Application Publication
(10) Pub. No.: US 2012/0203638 A1
(43) Pub. Date: Aug. 9, 2012

(54) System and Method for Establishing and Managing Short Code Campaigns

(76) Inventor: Mark Mitchell Kaplan, New York, NY (US)

(21) Appl. No.: 13/023,931

(22) Filed: Feb. 9, 2011

(51) Int. Cl. G06Q 30/00

(52) U.S. Cl. 705/14.64

(57) ABSTRACT

A campaign management system having a user interface that enables a content provider to initiate a request for a short code campaign, and identify information relating to the requested short code campaign; a first communication interface for communicating with a code registry; and a second communication interface for communicating with one or more carriers, each of which is capable of communicating with mobile devices using short code messaging. The campaign management system further includes a controller configured to receive the information for the requested short code campaign, reserve a short code with a code registry for use in the campaign via the first communication interface, activate the reserved short code with the one or more carriers via the second communication interface, and process messages received by the one or more carriers from end-users via the activated short code.

### TECHNICAL FIELD OF THE DISCLOSURE

This disclosure relates generally to promotional systems and more particularly, to a system and method for establishing and managing short code campaigns.

### BACKGROUND OF THE DISCLOSURE

Mobile messaging using short codes has become an important channel for marketing and promotions. Short codes are codes having fewer numbers than a typical telephone number, which are typically used to transmit text or multimedia messages using mobile communication devices. Marketers often place keywords on product and/or advertising, along with instructions for consumers to send those keywords to a certain short code number. Such campaigns enable consumers to obtain rebates, promotions, or coupons. In other instances, the consumer can obtain additional content related to the product or advertising, or subscribe to receive additional messages in the future.

However, there are significant limitations and drawbacks to the current system for implementing and maintaining short code campaigns. In order obtain a short code, a marketer or other content provider must manually reserve a desired short code number with a code registry. The marketer or content provider must then manually register the short code number and the associated campaign with each wireless carrier that will be implementing that campaign. The receipt and transmission of messaging content for the campaign is then operated by yet another separate agency. As a result, conflicts, changes, and modifications among campaigns are difficult, if not impossible to track or identify.

These limitations can lead to significant problems. For instance, short codes are often used and reused for multiple campaigns. If two campaigns are initiated in conjunction with a single short code using the same or similar short code, it may be difficult if not impossible to identify which campaign a consumer is interacting with. In the current environment, a content provider who has registered their short code with a carrier for a first campaign can also potentially initiate a new separate campaign without informing the carrier, or obtaining approval for the new campaign. This can create significant problems for the carrier, not only in operability, but also in terms of exposure to the extent that the new campaign violates legal requirements. For example, a recent law suit involved an instance where a minor who opted into a campaign with a certain short code later received adult content when a later adult-based campaign was initiated on that same short code. In yet another example, a law suit was brought when a marketer initiated a new campaign without providing appropriate methods for consumers to unsubscribe.

Accordingly, there is a need for an improved system and method for establishing and maintaining short code campaigns.

### SUMMARY OF THE INVENTIONS

The invention comprises novel systems and methods for establishing and processing short code messaging campaigns. The system includes at least one user interface that enables a content provider to initiate a request for a short code campaign, and identify information relating to the requested short code campaign. The system also includes a database for storing information relating to established short code campaigns, a first communication interface for communicating with a code registry, and a second communication interface for communicating with one or more carriers, each of which is capable of communicating with mobile devices using short code messaging. A controller is also provided and configured to receive the information for the requested short code campaign, reserve a short code with a code registry for use in the campaign via the first communication interface, activate the reserved short code with the one or more carriers via the second communication interface, and process messages received by the one or more carriers from end-users via the activated short code. The controller may also be configured to automatically validate at least a subset of the information relating to the requested short code campaign based on previously stored short-code campaign information in the database. In one embodiment, the system may also be configured to provide information regarding a requested short code campaign to a carrier via a second user interface in order to request the carrier to authorize the requested short code campaign

In another aspect, the present invention may include a method for establishing a short code campaign comprising the steps of receiving a request from a content provider to establish a short code campaign; obtaining a set of criteria for the short code campaign via a first user interface; establishing communication with a code registry via a first communication interface to reserve a short code number; automatically validating one or more criteria in the set of criteria based on information stored in a database; and establishing communication with one or more carriers via a second communication interface to activate the reserved short code number.

### BRIEF DESCRIPTION OF THE FIGURES

Various embodiment of the disclosure are now described, by way of example only, with reference to the accompanying figures.

FIG. 1 shows one embodiment of a system in accordance with the present invention.

FIG. 2 shows one embodiment of campaign management system 100 of FIG. 1 in accordance with the present invention.

FIG. 3 shows a flow diagram illustrating one potential embodiment of the functions provided by a content provider dashboard.

FIG. 4 shows a flow diagram illustrating one potential embodiment of the functions provided by a carrier dashboard.

FIG. 5 shows a flow diagram illustrating one potential embodiment of a process for submitting a short code campaign in accordance with the present invention.

FIG. 6 shows a flow diagram illustrating one potential embodiment of a process for creating and validating campaign information in accordance with the present invention.

FIG. 7 shows a flow diagram illustrating one potential embodiment of a process for performing authorization of a campaign in accordance with the present invention.

FIG. 8 shows a flow diagram illustrating one potential embodiment of a process for updating campaign information in accordance with the present invention.

FIG. 9 shows a flow diagram illustrating one potential embodiment of a process for supporting and processing a short code campaign in accordance with the present invention.

Skilled artisans will appreciate that elements in the figures are illustrated for simplicity and clarity so not all connections and options have been shown to avoid obscuring the inventive aspects. For example, the dimensions and/or relative positioning of some of the elements in the figures may be exaggerated relative to other elements to help improve the understanding of various embodiments of the present disclosure. Also, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence may not be actually required, except as may be limited by the claims. It will also be understood that the terms and expressions used herein are to be defined with respect to their corresponding respective areas of inquiry and study except where specific meaning have otherwise been set forth herein.

### DETAILED DESCRIPTION OF THE DISCLOSURE

The present invention provides systems and methods for receiving requests for, validating, and establishing promotional or marketing campaigns via short code messaging. As would be understood by those skilled in the art, short codes are codes having fewer numbers than a typical telephone number, and which are typically used to transmit text or multimedia messages. Generally, short codes are 5 or 6 digit numbers, although it is understood that a short code having fewer digits may also be used.

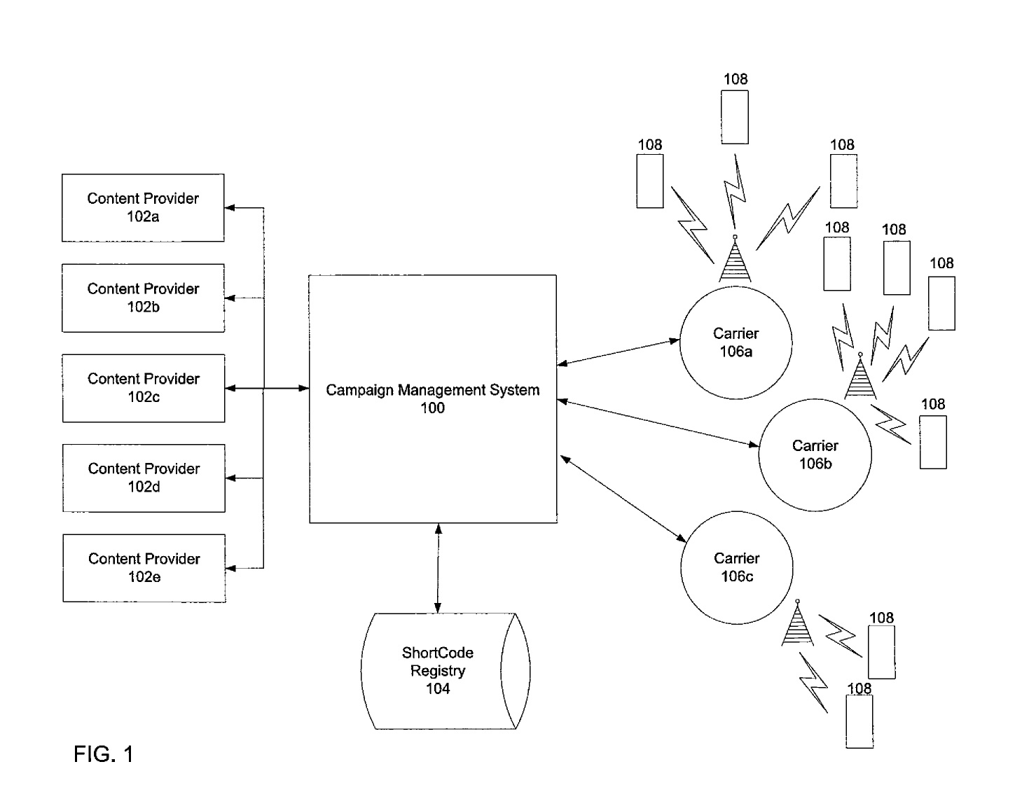

As shown in FIG. 1, a campaign management system 100 is provided that is configured to communicate with content providers 102a-e and a code registry 104. Such communication may be within the same local area network, but it is more likely that campaign management system 100, content providers 102 and short code registry 104 will not be located within the same local area network and thus may communicate through a variety of conduits including, but not limited to via the internet. For purposes of this disclosure, a “content provider” may be any entity that desires to establish a short code messaging campaign. Thus, the content provider may be a entity that manufactures and/or sells products (which may be goods, services, downloadable content, etc.), or any wholesaler, retailer, etc. of such products. The content provider may also be an agency or other developer that operates on behalf of a manufacturer, wholesaler, retailer, etc. to establish short code campaigns. A “short code registry” may be any entity that maintains a database of short codes, and enables others to reserve or obtain rights in those short codes. For example, in the United States, the predominant short code registry is the Common Short Code Administration (CSCA).

The system is also configured to communicate with a plurality of carriers 106a-c, each of which is capable of communicating with one or more end-user mobile devices 108. Again such communication is likely to be between a plurality of networks through a variety of conduits including, but not limited to via the internet. For purposes of this disclosure, a “carrier” may be any mobile operator or carrier service provider that provides wireless communications services for subscribers. For example, in the United States, such carriers include AT&T, Verizon, Sprint, T-Mobile, U.S. Cellular, and the like.

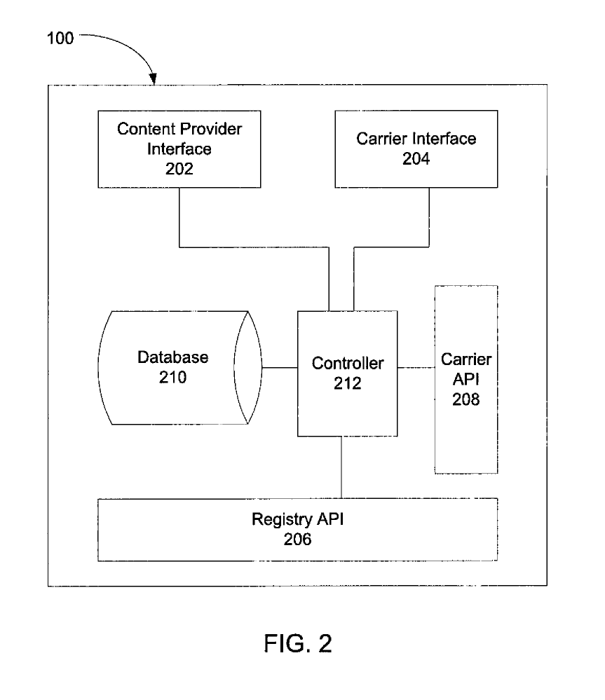

FIG. 2 illustrates one exemplary embodiment of a campaign management system 100 in accordance with the present invention. The campaign management system 100, as shown, may include a plurality of user interfaces, including one or more content provider interfaces 202 and carrier interfaces 204, that enable content providers 102 and carriers 106, respectively, to communicate with the system 100 in order to establish and manage one or more short code campaigns. The interfaces may be configured to enable content providers 102 and carriers 106 to communicate with the system 100 using any one of a plurality of communication methods. For example, the system may include user interfaces to enable content providers and/or carriers to communicate via client-based applications in communication with the system 100, Internet-based web sites, mobile web sites, SMS, voice SMS, instant messaging, interactive voice response (IVR) via any audio connection with DTMF (mobile phone, landline, etc.), or the like.

The campaign management system 100 also includes various communication interfaces. For instance, in the embodiment shown in FIG. 2, the system 100 includes a registry application programming interface (API) 206 that enables the system 100 to access and communicate with the services and resources of the short code registry 104. A carrier API 208 is also provided that enable the system 100 to access and communicate with the services and resources operated by each of the Carriers 106. It should be understood that various carriers may utilize different standards and protocols for their services and resources. Therefore, although a single block is used to illustrate the carrier API in FIG. 2, different APIs may be needed in order to communicate with the differing systems and requirements of each respective carrier 106.

The campaign management system 100 also includes a database 210 and a controller 212. The database may be configured to store each short code that has been reserved by each content provider, information regarding the campaign or campaigns associated with each short code, and any keywords associated with that campaign. The campaign information may include, but is not limited to content provider, program sponsor, campaign name, textual summary describing campaign, whether the campaign is/was a pilot campaign, geographic reach for campaign, campaign keywords, campaign start and end dates, campaign type (e.g. sweepstakes, fact finding, survey, alerts, lifecycle, trial, and redemptions), and campaign screen flows. The database 210 also preferably stores information about unapproved campaigns preferably including the foregoing information provided for approved campaigns and further including the reason(s) for campaign rejection. For approved campaigns, the database 210 will include information identifying end users subscribed to the campaign.

The database 210 also preferably stores information identifying each end-user who had opted in for at least one campaign. The end-user stored in the database 210 may include the end-user name, address, date of birth, email address, telephone number, mobile number, and mobile device type and may further include opt-in date, opt-out date, and the keyword that was utilized by that end-user in order to opt-in. Preferably the database 210 is constructed so as to preclude the ready association of the mobile telephone number with the other end-user information stored in the database 210, especially by content providers and/or carriers.

The database 210 may further include information regarding each content provider, such as the nature of the content provider (e.g. restaurant, mass marketer, alcohol distributor, tobacco company, OTC drug company, adult-based content provider), content provider approved policies, and contact information for the campaign and/or content provider campaign administrator, the short codes associated with the content provider, and information regarding the campaigns established by the content provider (e.g. date range, nature of campaign, special criteria associated with campaign).

Although the database 210 is shown as being a physical part of the system 100, one skilled in the art having the present specification before them would understand that one or more remote databases could be used, some of which may even be deployed in the cloud. It would also be similarly understood that the information could be stored among a number of distributed databases.

The controller 212 is configured to manage and process information communicated between and among the user interfaces 202 and 204, the registry API 206, carrier API 208, and the database 210 in order to enable the creation, setup, and management of one or more short code campaigns. Various exemplary processes for performing these functions are described in more detail below.

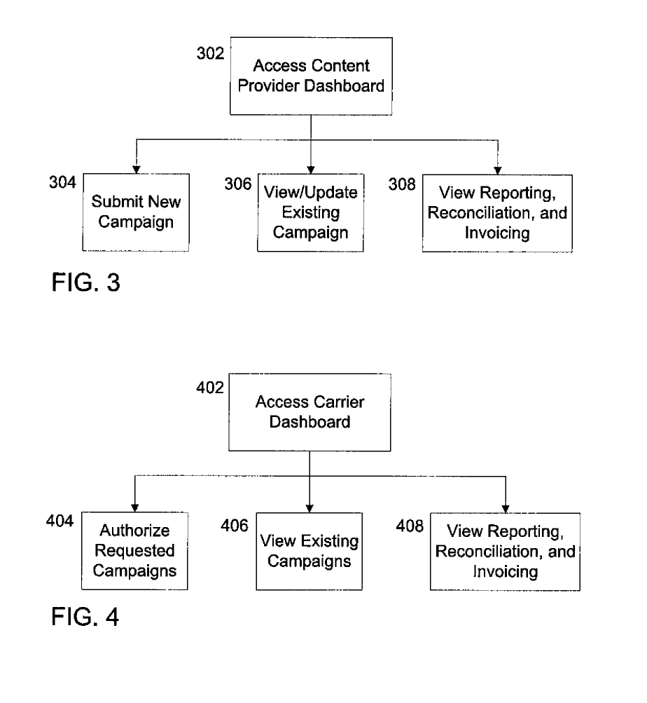

FIGS. 3 and 4 illustrate the general functionality available to content providers 102 and carriers 106 through the content provider interface 202 and the carrier interface 204, respectively. As shown in FIG. 3, when a content provider 102 accesses the system 100 via a content provider interface 202 in step 302, the content provider 102 may be permitted to submit a new campaign in step 304, view and/or update existing campaign information in step 306, or view any reports, reconciliation, or invoicing information for existing campaigns in step 308. Turning to FIG. 4, when a carrier 106 accesses the system 100 via a carrier interface in step 402, the carrier 106 may be permitted to review and authorize campaign setup requests in step 404, view information regarding previously established campaigns in step 406, or view any reports, reconciliation, or invoicing information for existing campaigns in step 408.

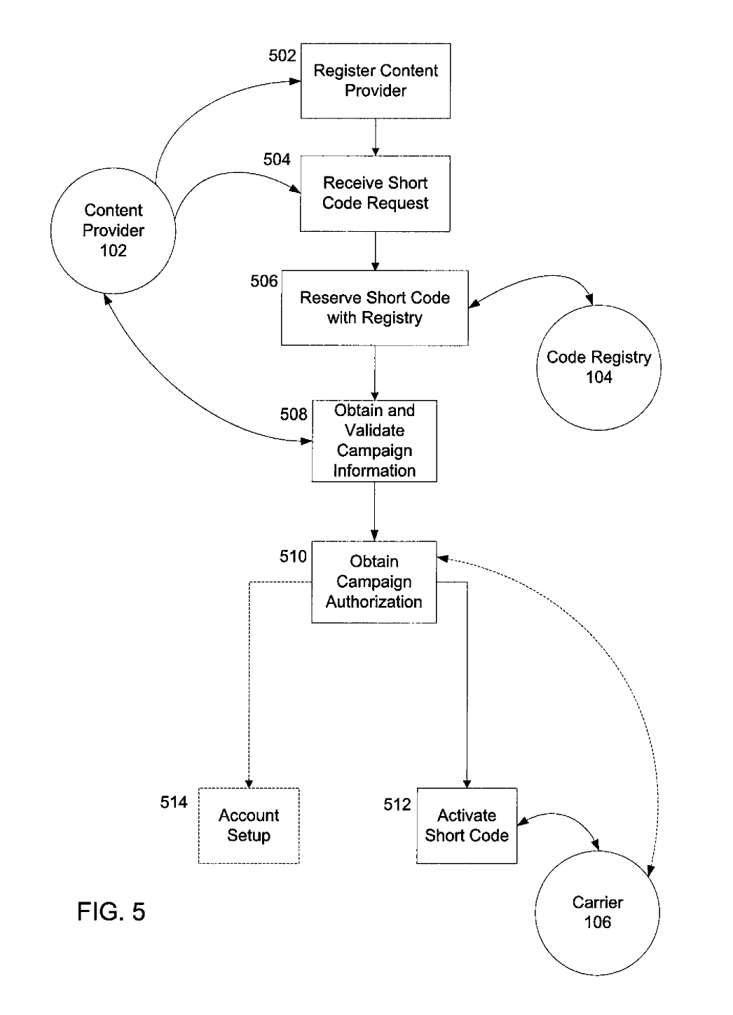

FIG. 5 illustrates one exemplary process for establishing a new short code campaign in accordance with the present invention. In step 502, a content provider 102 that desires to establish a new campaign is registered by the system 100. In one embodiment, in order to become registered, a content provider may be required to establish that it has appropriate privacy policies, terms of service, and data protection procedures in place. The content provider may also be required to agree to a set of guidelines for implementing short code campaigns. Once registered, the content provider may be provided with a login and password (which may be automatically set or selected by the content provider) for accessing the content provider interface 202. Once registered, the policies provided by the content provider may be stored in the database 210 for future reference.

In step 504, a request for one or more short codes is received from an approved/registered content provider 102. In making the request for one or more short codes, the content provider 102 may be requested to provide certain additional information. For example, for each requested short code, a content provider 102 may be requested to identify whether use of the short code should be free to the end user, whether standard messaging rates should apply, or whether some custom pricing should be applied. The content provider 102 may also be requested to identify whether the short code can be any random number or whether a specific vanity number is desired for the campaign. The content provider 102 may further be requested to identify whether the short code should be exclusive to a single campaign or whether it can be shared with other campaigns. The short code may be randomly generated or manually selected. Where the content provider 102 manually selects the short code, the code will be validated against previously assigned short codes in database 210 as well as database of impermissible codes, which may include codes whose numbers spell out undesirable words.

In step 506, the system 100 establishes communications with the code registry 104 via the registry API 206 and attempts to reserve a short code based on the criteria identified by the content provider 102. If successful, the content provider 102 is notified and the process proceeds to step 508. However, if there is no short code available that meets the identified criteria, the content provider may be notified and requested to alter their criteria.

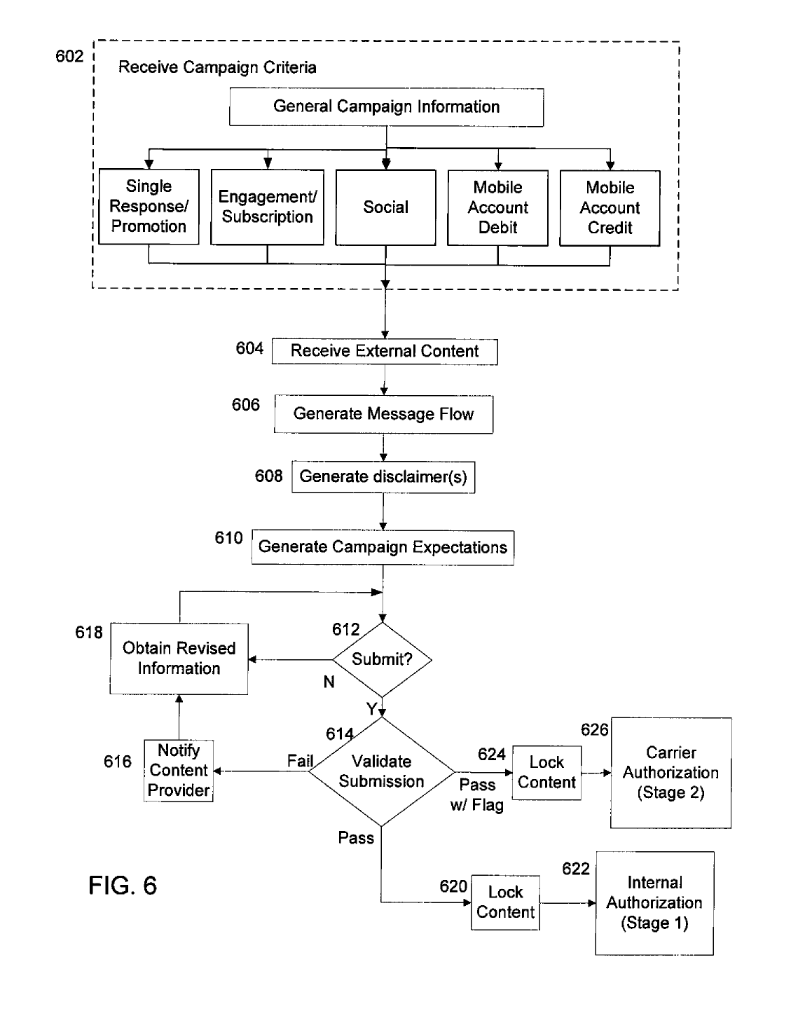

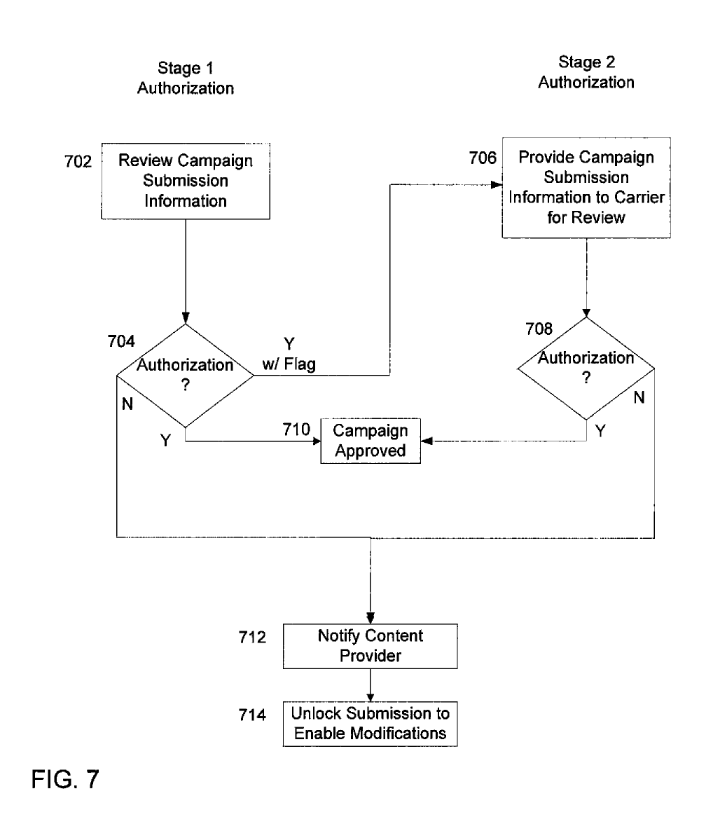

In step 508, the details for the requested campaign are entered by the content provider 102 via the content provider interface 204, and then automatically validated by the campaign management system 100. One exemplary process for identifying and validating campaign information is described in more detail below with respect to FIG. 6. A campaign request may also be submitted for an additional manual authorization in step 510. In one embodiment, authorization may be performed by an operator, administrator, or other individual associated with the content management system 100 (hereinafter referred to as a “campaign administrator”). Alternatively, authorization may be requested from the carrier 106. One example of an authorization process in accordance with the present invention is described in more detail below with regards to FIG. 7.

If a campaign has been approved (i.e. validated and/or authorized), the campaign management system 100 establishes communication with each appropriate carrier 106, via the carrier API 208, to automatically publish and activate the short code in the carrier's systems based on the details provided by the content provider 102 in step 508. In other words, if a campaign will be deployed on five carriers 106 then the management system 100 establishes communication with each of the five carriers via the carrier API 208 by providing the information required for each carrier according to the particular syntax of each carrier.

If the campaign account is one that involves a credit or debit account to be utilized, the campaign management system 100 may also establish a segregated campaign account and certify the account setup with each carrier. In the case of a debit account campaign, the system 100 may also request the content provider to fund the account with an initial payment representing the campaign specified rebates and associated transaction fees. The credit and debit accounts may be used to provide either pre-paid (in the case of credit accounts) or post-pay (in the case of debit accounts) credits, rebates, or similar promotions to consumers. In one embodiment, the credits, rebates, or the like can be applied to the consumer's monthly wireless service bill, although it is contemplated that they can also be applied to any other type of account including, but not limited to, the bills of any other entity or service provider, the consumer's credit card account, and a virtual debit account associated with the consumer.

FIG. 6 describes one exemplary process for obtaining and validating campaign information in accordance with one potential embodiment of the present invention. After logging into the content provider interface 202 of the system 100, in step 602, the system 100 prompts the content provider 102 to provide the campaign criteria. This may include general campaign information that is applicable to most or all campaign types, including the name of the campaign, the type of campaign being requested, a general description of the campaign, identification of any program sponsors, an indication of whether the campaign is a pilot program, the regions or countries for the campaign, the selected mobile operators/carriers to be used for the campaign, the short codes to be used for the campaign, the keywords to be used for the campaign, and the campaign start and end dates. The content provider 102 may also be prompted to provide additional information relevant to a specific type of campaign being requested. For instance, for single response/promotion campaigns, the content provider 102 may be requested to provide a list of mobile originating command codes, responses, and error codes; any desired limits on mobile originating messages by keyword; and/or any mobile termination rules (i.e. time of day, frequency, etc.). For engagement/subscription campaigns, the content provider 102 may be requested to provide a list of mobile originating command codes, responses, and error codes; a list of mobile terminating messages and business rules, and/or any mobile termination rules. For social campaigns, the content provider 102 may be requested to provide a list of mobile originating command codes, responses, and error codes; an mobile originating message template for customer-created messages; a list of mobile terminating messages and business rules, and/or mobile termination rules. For mobile account debit or credit campaigns, the content provider 102 may be requested to provide a campaign interaction/transaction limit per customer, and/or a preset dollar amount or limit per interaction. Of course, it should be understood that the campaign types discussed herein are provided merely as examples of potential types of campaigns that could be established using system 100. Those of ordinary skill in the art having the present specification before them would understand that other types of campaigns may also be implemented, and other types of information may also be gathered by the system.

In step 604, the campaign management system 100 also requests the content provider to identify any external content that may be utilized in conjunction with the campaign. For example, this may include the content provider's privacy policy, terms and conditions, and customer service contact information. It may also include any digital content that is to be used for the campaign (i.e. photos, videos, music, or other media that may be transmitted or otherwise provider to end-users), and any advertising that may be associated with the campaign. The content may be provided in any one of various ways. For instance, the content may be directly uploaded electronically to the content management system 100. Alternatively, the content provider 102 may provide the campaign management system 100 with access to a database or server on which the content has been and will be stored. In yet another embodiment, if the content is available via the internet (as if often the case with privacy policies, and terms and conditions), the content provider 102 may identify a URL linking to the appropriate content. The external content provided to the system 1001 stored in an accessible manner in database 210.

In step 606, one or more message flows are automatically generated by the campaign management system 100 for the requested campaign. This may include any message flows that are deemed appropriate for the requested type of campaign, including opt-in flows for both on-device and off-device opt-ins, opt-out flows, help message flows, main program message flows, and age and state verification flows. As would be understood by those skilled in the art having the present specification before them, other types of message flows may also be automatically generated based on the circumstances and the type of campaign being requested. The message flows may also be generated in one or more languages based on the campaign submission information. In one embodiment, the content provider may be permitted to simply select each language to be used. However, the message flows may also be automatically generated based on the official language of each country selected for the campaign, or based on the language preferences of each carrier selected for the campaign. Once the message flows are generated, the content provider 102 may be provided with an option—via the content provider interface 202—to revise any of the automatically generated message flows and/or to manually input additional message flows.

As an example, below is one illustrative set of message flows that may be generated for a campaign in which consumer can text a keyword (obtained, for example, by purchasing a product) to a shortcode in order to receive a rebate on their wireless service bill.
1) User Sends Valid Code or enters mobile number from website:
Thanks for ur interest in BrandCampaign! Please reply w/ur AGE & RESIDENT STATE (ex. 22 TX). Reply HELP for Help, STOP 2quit, msg&data rates may apply.!
   a. If valid state/age:
   Thx 4 buying Brand! Ur savings will b on ur mobile bill w/in 60 days. Reply HELP for Help, STOP 2quit, msg&data rates may apply.
   b. If invalid state/age:
   BrandCampaign: Sorry, but this offer is not valid in ur state or u do not qualify b/c of age. Reply HELP for Help, STOP 2quit, msg&data rates may apply.
2) User Sends Repeat Code:
BrandCampaign: Sorry but this code has already been used. Please try again or enter a new code. Reply HELP for Help, STOP 2quit, msg&data rates may apply.
3) User Attempts 2 Redemptions:
BrandCampaign: Sorry but only 1 credit per phone can be redeemed. Reply HELP for Help, STOP 2quit, msg&data rates may apply.
4) User Sends Invalid Code:
BrandCampaign: We're sorry but this code is invalid. Please try again or enter a new code. Reply HELP for Help, STOP 2quit, msg&data rates may apply.
5) User Sends Junk Response (like . . . “Bob” or “asdf”):
BrandCampaign: We're sorry but this code is invalid. Please try again or enter a new code. Reply HELP for Help, STOP 2quit, msg&data rates may apply.
6) If user sends “help”:
For assistance with BrandCampaign, please contact CustServ#. Reply STOP 2quit, msg&data rates may apply.
7) If user sends “stop”:
You have unsubscribed from BrandCampaign and will no longer receive any more messages. Questions? please contact CustServ#.
8) If user sends a text after the program has ended:
Sorry, BrandCampaign has ended. Please continue to visit URL to enter ur codes! Reply HELP for Help, STOP 2quit, msg&data rates may apply.

In step 608, the campaign management system 100 automatically generates terminology to be used for advertising disclaimers in any print, radio, television, or other advertising media associated with the campaign in accordance with the present invention. A set of campaign expectations are also automatically generated in step 610. This may include, for example, a display illustrating bill line items, and corresponding descriptions, may appear on credit or debit statements for an end-user. It may also include information regarding the duration of time that will be required to apply any credits or debits to an end-user's account.

In step 610, the content provider may review each of the elements of the campaign and determine whether to submit the campaign. In step 612, the various campaign details are automatically validated. For example, any short codes identified by the content provider for use with the campaign may be automatically validated against existing short codes stored in the database 210 to assess whether the identified short code is available and/or appropriate for use in the requested campaign. Any keywords provided by the content provider 102 for use in the campaign may also be validated against existing campaigns stored in the database and their associated keywords in order to identify and limit potential conflicts between various campaigns. The keywords, as well as the campaign start and end dates may also be validated against any previously established guidelines for each carrier, as well as the terms and conditions of any contracts associated with the content provider. Any preset limits for mobile account debit or credit campaigns may also be validated against limits set by carriers.

Message flows may also be validated against a set of carrier rules stored in the database. For example, the system may assess whether the terminology used in the message flows complies with a carrier's specifications. For instance, a few carriers' specifications may prohibit the use of profanity and some carriers may prohibit advertising of tobacco. Preferably database 210 will also contain information about campaigns that have been rejected by one or more carriers, long with the identity of the carriers rejecting the campaign, and the terms, terminology, or subject matter that led to the carrier's rejection of the campaign for use in improving the automated validation search. In another example, the message flows may also be reviewed to ensure that there is no reference to short codes other than those that have been explicitly identified as part of the campaign in the database 210.

Of course, while certain examples of information requiring validation has been described, other information may also be automatically validated. Additionally, while validation is shown as being performed after submission, it should be understood that various steps, including the validation step, may be performed at other points during the campaign creation phase. Different aspects of the validation process may also be performed at various instances. For example, information that is provided by the content provider and/or generated in response to the content provider's criteria may be validated at the time that it is provider and/or generated.

As illustrated in FIG. 6, in one embodiment, there may be three potential outcomes as a result of the validation process: failed validation; passed validation with flag and passed validation. If the campaign submission is considered, in step 614, to have failed validation, then the content provider may be notified of the reason for rejection in step 616 and permitted to modify the campaign information and/or content in step 618 to avoid the rejection. The campaign submission may fail if the campaign fails to comply with one or more preset requirements. For example, if the content provider manually creates a message flow without an opt-out option, or content provider removes the opt-out option from an automatically created message flow, the campaign submission may be automatically rejected.

If the campaign submission is determined to have passed validation, the campaign data is locked to prevent further modification in step 620, and an Internal Authorization (also referred to herein as Stage 1 Authorization) is requested in step 622. If the campaign submission is determined to have passed, but is also flagged as having questionable information or content, then the submission is locked to prevent further modification changes in step 624, and a Carrier Authorization (also referred to herein as Stage 2 Authorization) is requested in step 626. As one example, a flag for questionable information or content may be triggered for a campaign submission if any terminology, references, or other content associated with the campaign submission appears to violate a carrier's code of conduct, such as references to gambling, pornography, alcohol, tobacco, fire arms, etc.

As each carrier may have differing codes of conduct, it is therefore also contemplated that the validation process may also produce different outcomes for each carrier. For instance, a single campaign submission that designated for implementation with two carriers may be passed for one carrier but failed or flagged with respect to the other carrier.

FIG. 7 illustrates one exemplary process for authorizing a campaign submission. If a Stage 1 authorization was initiated (see step 622 in FIG. 6), the authorization process begins at step 702. In step 702, the campaign submission information is provided to a campaign administrator, who accesses the database 210 and reviews the campaign submission information to manually determine whether to authorize the campaign submission information in step 704. If the campaign submission is authorized, the campaign is deemed approved in step 710 and is registered as a live campaign with the appropriate carriers. If the campaign submission is not authorized, the content provider is notified of the problem in 712 and the campaign submission is unlocked (step 714) so that the content provider can make modifications to the submission. When a submitted campaign is approved or rejected the content provider may be notified by email or by other means as would be understood by those of ordinary skill in the art having the present specification before them.

In step 704, the campaign administrator may also choose to authorize the campaign submission, but to flag it as having questionable information. In this case, the process proceeds to step 706 for Stage 2 authorization. The authorization process also begins at step 706, if a Stage 2 authorization was initiated in the primary validation process (see step 626 in FIG. 6).

In step 706, the campaign submission information is provided to the relevant carrier or carriers for authorization. The campaign submission information may be provided to each carrier via the carrier interface. However, other methods may also be used. For instance, the campaign submission information may be transmitted to each carrier via email. In one embodiment, the information provided to the carrier may include only the information flagged as being questionable. Alternatively, the entirety of the campaign submission information, or a certain subset thereof information, may be provided.

After reviewing the campaign submission information, the carrier 106 determines whether to authorize the submission. If the campaign submission is authorized, the campaign is deemed approved in step 710 and is registered as a live campaign. If the campaign submission is not authorized, the content provider 102 is notified of the problem in 712 and the campaign submission is unlocked so that the content provider can make modifications to the submission.

To obtain a prompt review, carriers may also be provided with reminders via email, SMS or other medium if they fail to approve or deny a campaign submission within a predetermined period of time. In one embodiment, if the carrier does not deny or otherwise object to a campaign submission after a certain amount of time and/or after a certain number of reminders, then the campaign submission may automatically be considered authorized.

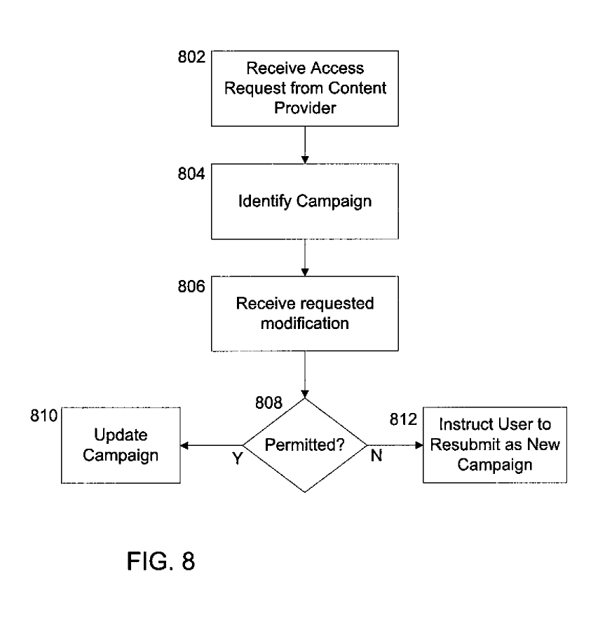

FIG. 8 illustrates one exemplary method for updating campaign information. In step 802, a request is received from a content provider 102 to access the carrier interface 202. The content provider 102 identifies a campaign to be updated in step 804 and requests modification to certain campaign information in step 806. In step 808, it is determined whether the requested modification is permissible without revalidation and/or reauthorization. If the modification is permitted, the campaign information is updated per the request in step 810. However, if the modification is not permitted, the content provider is notified as such, and is instructed to submit the modified information as a new campaign submission. In a preferred embodiment, the only modifications that may be made, without requiring submission of a new campaign, are to the content provider's privacy policy, the content providers terms and conditions, the customer service contact information, the keywords being used for the campaign, the start and end dates for the campaign. the advertising materials, the message flow, the digital content for the campaign, the end-user transaction limits, or the dollar amounts for mobile debit or credit campaigns. Although not shown in FIG. 8, it should also be understood that any modified data may be subject to validation and/or authorization as described above.

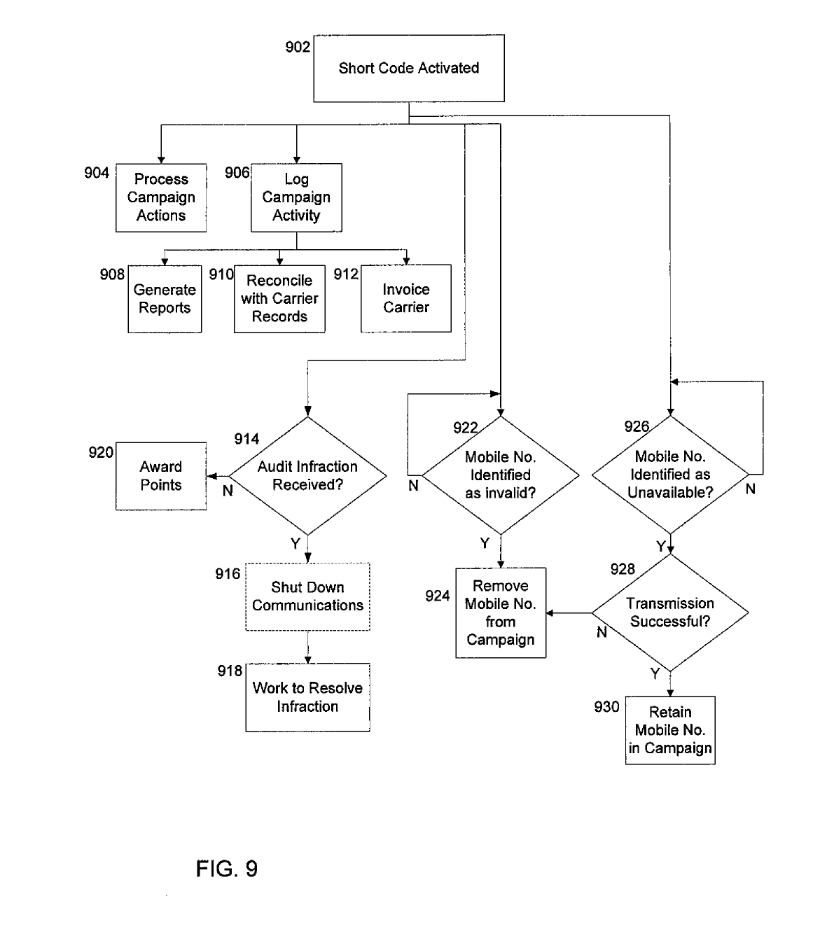

FIG. 9 describes one exemplary process for supporting and processing an established and live campaign in accordance with the present invention. Once a short code campaign is activated in step 902, the campaign management system 100 processes required campaign actions in step 904 based on the campaign submission information provided by the content provider. This may include, for example, managing message flows to end-users, end-user opt-ins and opt-outs, and any debit, credit, or other transactions.

In step 906, the campaign management system 100 also logs any campaign activity, which is stored preferably in the database 210. After milestones are reached within the campaign or periodically, the system 100 may generate various reports relating to the campaign activity and transactions in step 908, which may be provided to content providers 102 and/or carriers 106 via the content provider interface 202 and the carrier interface 204, respectively. The campaign management system 100 may also, if applicable, report successful debits, credits, and content downloads by end-user, and reconcile the amounts with the carriers in step 910. In step 912, the campaign management system 100 may also invoice the carriers for any credit payments made during the processing of the campaign.

The campaign management system 100 may also be configured to receive indications of any audit infractions from the carrier. As one example, an audit infraction may occur if there is an irregularity regarding message volumes between the carrier's actual traffic and the traffic as reported by the campaign management system 100. Such an irregularity may occur if the campaign management system is misconfigured by the content provider and therefore does not recognize transactions properly, resulting in an inconsistency between the traffic logs of the carrier and the campaign management system 100. As other examples, audit infractions may also occur if the carrier reports unexpected billing events or the content of received messaging do not correlate to the advertising for the content provider. Such infractions may, in one embodiment, be triggered by customer support inquiries from the carrier's subscribers.

If, in step 914, it is determined that an audit infraction has been received, the campaign management system 100 may, depending on the severity of the infraction, shut down the campaign in step 916 and work with the content provider to resolve the infraction in step 918. However, if it is determined that an audit infraction has not been received for a certain campaign for a period of time, the campaign management system may award a certain number of points or credits to the content provider. In one embodiment, the points and/or credits may be used as intra-system currency to subsidize the costs of future messaging charging in the current campaign or in future campaigns initiated by the content provider. For instance, a content provider may typically be charged 5 cents per message. The content provider may then be awarded 10000 message credits for having no audit infractions for a given campaign over a 6 month period. As a result, the content provider could redeem the credits for 10000 future messages, realizing a cost savings of $500.

The campaign management system 100 may also be configured to receive from each carrier 106 an indication that a mobile number for end-user who has previously opted in for the campaign is either invalid or temporarily unavailable. If, in step 922, it is determined that an end-user's mobile number is invalid or disconnected, that number is removed from the campaign in step 924 so that further communications are not transmitted to the number. If an end user's mobile number is identified as being temporarily unavailable in step 926, the campaign management system 100 will reattempt to send the message until the carrier either indicates, in step 928, that the transmission was successful or that the mobile number is invalid. If the transmission was determined to be successful, the mobile number is retained in the campaign program in step 930. If the transmission was not successful and the mobile number is deemed invalid, that number is removed from the campaign in step 924.

In one embodiment, if the mobile number is deemed invalid, the campaign management system may further be configured to identify any other campaigns stored in the database 210 for which that mobile number has previously opted-in, and then remove the mobile number from those campaigns as well. By doing so, the number of unsuccessful transmissions across all campaigns is limited, thereby reducing both unnecessary messaging traffic as well as minimizing unnecessary costs to the content providers of such campaigns.

Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure cover all such modifications and variations provided they come within the scope of the following claims and their equivalents.

What is claimed is:

1. A campaign management system comprising:
a first user interface that enables a content provider to initiate a request for a short code campaign, and identify information relating to the requested short code campaign;
a first communication interface for communicating with a code registry;
a second communication interface for communicating with one or more carriers, each of which is capable of communicating with mobile devices using short code messaging; and
a controller configured to receive the information for the requested short code campaign, reserve a short code with a code registry for use in the campaign via the first communication interface, activate the reserved short code with the one or more carriers via the second communication interface, and process messages received by the one or more carriers from end-users via the activated short code.

2. The system of claim 1 further including a database for storing information relating to a plurality of short code campaigns, wherein the controller is further configured to automatically validate at least a subset of the information relating to the requested short code campaign based on previously stored short-code campaign information in the database.

3. The system of claim 2 wherein the a first user interface enables a content provider to identify one or more keywords to be used for the short code campaign; and wherein the controller is configured to automatically validate the one or more keywords based on keywords identified in the database for previously established short code campaigns.

4. The system of claim 2 wherein the controller is configured to automatically validate the at least one criteria based on guidelines established by the one or more carriers.

5. The system of claim 1 wherein the controller is further configured to automatically generate one or more message flows for the short code campaign based on the information identified by the content provider.

6. The system of claim 1 further comprising a second user interface that enables a carrier to access information regarding the requested short code campaign.

7. The system of claim 1 wherein the second user interface is configured to enable the carrier to review information relating to the requested short code campaign and authorize the requested short code campaign prior to the controller activating the short code.

8. The system of claim 7 wherein the information reviewed by the carrier includes a set of proposed message flows for the requested short code campaign.

9. The system of claim 7 wherein the information reviewed by the carrier includes at least one of a proposed advertising for the short code campaign, a privacy policy for the content provider, or a terms and condition for the content provider.

10. A method for establishing a short code campaign comprising:
receiving a request from a content provider to establish a short code campaign;
obtaining a set of criteria for the short code campaign via a first user interface;
establishing communication with a code registry via a first communication interface to reserve a short code number
automatically validating one or more criteria in the set of criteria based on information stored in a database; and
establishing communication with one or more carriers via a second communication interface to activate the reserved short code number.

11. The method of claim 10 wherein obtaining a set of criteria for the short code campaign includes receiving from the content provider, via the first user interface, one or more keywords to be used for the short code campaign.

12. The method of claim 10 wherein obtaining a set of criteria for the short code campaign includes automatically generating one or more message flows for the short code campaign.

13. The method of claim 10 wherein obtaining a set of criteria for the short code campaign includes automatically generating at least one disclaimers to be utilized in conjunction with advertising for the short code campaign.

14. The method of claim 10 further including automatically validating at least a subset of the set of criteria based on guidelines established by the one or more carriers.

15. A The method of claim 12 further including automatically validating the one or more keywords based on a set of keywords stored in the database for previously established short code campaigns.

16. The method of claim 10 further including requesting at least one of the one or more carriers to authorize the requested short code campaign via a second user interface.
